(19) United States
(12) Patent Application Publication
(10) Pub. No.: US 2015/0030749 A1
(43) Pub. Date: Jan. 29, 2015

(54) SOLUTION CONTAINING COMPONENTS OF STARTING PLANT RAW MATERIAL, BEVERAGE, AND METHOD RELATING THERETO

(71) Applicant: SAPPORO BREWERIES LIMITED, Shibuya-ku, Tokyo (JP)

(72) Inventors: Takayuki Kosugi, Shibuya-ku (JP); Yoichi Kozaki, Shibuya-ku (JP); Masayuki Shimase, Shibuya-ku (JP)

(73) Assignee: SAPPORO BREWERIES LIMITED, Shibuya-ku, Tokyo (JP)

(21) Appl. No.: 14/384,530

(22) PCT Filed: Mar. 8, 2013
(86) PCT No.: PCT/JP2013/056521

§ 371 Date: Sep. 11, 2014

(30) Foreign Application Priority Data
Mar. 28, 2012 (JP) 2012-075130

(51) Int. Cl. A23L 2/56; A23L 2/38

(52) U.S. Cl. CPC A23L 2/56; A23L 2/38; A23V 2002/00
USPC 426/590; 426/425

(57) ABSTRACT

Provided are a plant raw material liquid and a beverage that are reliably prevented from containing an alcohol and have excellent flavor, and a method related thereto. A method according to the present invention includes bringing a first plant raw material liquid into contact with inactivated yeast to produce a second plant raw material liquid to be used for production of a beverage. The method may also further include producing the beverage using the second plant raw material liquid.

### TECHNICAL FIELD

The present invention relates to a plant raw material liquid and a beverage, and a method related thereto, and more particularly, to an improvement in flavor of a plant raw material liquid and a beverage produced using the plant raw material liquid.

### BACKGROUND ART

In the related art, for example, Patent Literature 1 discloses a cold contact process for production of non-alcoholic malt beverages, the process involving bringing wort into contact with yeast at a temperature of more than 0° C. and less than 7° C.

### CITATION LIST

### Patent Literature

[Patent Literature 1] JPH08-509855 A

### SUMMARY OF INVENTION

### Technical Problem

Hitherto, however, it has been difficult to reliably prevent the production of an alcohol due to yeast in wort even at a low temperature of more than 0° C. and less than 7° C. In addition, for example, the related-art non-alcoholic beverages need to be improved in flavor.

The present invention has been made in view of the problems, and one of the objects of the present invention is to provide a plant raw material liquid and a beverage that are reliably prevented from containing an alcohol and have excellent flavor, and a method related thereto.

### Solution to Problem

A method according to one embodiment of the present invention for achieving the above-mentioned object includes bringing a first plant raw material liquid into contact with inactivated yeast to produce a second plant raw material liquid to be used for production of a beverage. According to one embodiment of the present invention, there is provided a method of producing a plant raw material liquid and/or a beverage having excellent flavor while reliably preventing production of an alcohol by yeast.

In addition, in the method, the bringing of the first plant raw material liquid into contact with the inactivated yeast may be performed under heating. In addition, in the method according to any one of the above-mentioned embodiments, the bringing of the first plant raw material liquid into contact with the inactivated yeast may include adding a living yeast to the first plant raw material liquid at a temperature for inactivation of the living yeast to inactivate the living yeast and to bring the first plant raw material liquid into contact with the inactivated yeast obtained by the inactivation of the living yeast. In addition, in the method according to any one of the above-mentioned embodiments, the bringing of the first plant raw material liquid into contact with the inactivated yeast may be performed at a temperature of 20° C. or more.

The method according to any one of the above-mentioned embodiments may further include producing the beverage using the second plant raw material liquid. In this case, according to one embodiment of the present invention, there is provided a method of producing a beverage having excellent flavor while reliably preventing production of an alcohol by yeast. In addition, the beverage may be a non-alcoholic beverage.

A method according to one embodiment of the present invention for achieving the above-mentioned object includes bringing a plant raw material liquid into contact with inactivated yeast to improve flavor of the plant raw material liquid compared to that before the contact with the inactivated yeast. According to one embodiment of the present invention, there is provided a method of effectively improving flavor of a plant raw material liquid while reliably preventing production of an alcohol by yeast.

A method according to one embodiment of the present invention for achieving the above-mentioned object is a method of improving flavor of a beverage, including using a second plant raw material liquid obtained by bringing a first plant raw material liquid into contact with inactivated yeast to improve flavor of the beverage compared to that in a case of using the first plant raw material liquid that has not been brought into contact with the inactivated yeast. According to one embodiment of the present invention, there is provided a method of effectively improving flavor of a beverage while reliably preventing production of an alcohol by yeast. In addition, the beverage may be a non-alcoholic beverage.

A plant raw material liquid according to one embodiment of the present invention for achieving the above-mentioned object is produced by the method according to any one of the above-mentioned embodiments. According to one embodiment of the present invention, there is provided a plant raw material liquid that is reliably prevented from containing an alcohol and has excellent flavor.

A beverage according to one embodiment of the present invention for achieving the above-mentioned object is produced by the method according to any one of the above-mentioned embodiments. According to one embodiment of the present invention, there is provided a beverage that is reliably prevented from containing an alcohol to be produced by yeast and has excellent flavor. In addition, the beverage may be a non-alcoholic beverage.

### Advantageous Effects of Invention

According to one embodiment of the present invention, the plant raw material liquid and beverage that are reliably prevented from containing an alcohol and have excellent flavor, and the method related thereto are provided.

### BRIEF DESCRIPTION OF DRAWINGS

FIG. 1 is an explanatory diagram showing examples of evaluation results of relationships between temperatures at which a first plant raw material liquid is brought into contact with inactivated yeast and flavor of a second plant raw material liquid produced in Example 1 according to one embodiment of the present invention.

FIG. 2 is an explanatory diagram showing examples of evaluation results of relationships between amounts of the inactivated yeast with which the first plant raw material liquid is brought into contact and the flavor of the second plant raw material liquid produced in Example 2 according to one embodiment of the present invention.

FIG. 3 is an explanatory diagram showing examples of evaluation results of relationships between time for contact of the first plant raw material liquid with the inactivated yeast and the flavor of the second plant raw material liquid produced in Example 3 according to one embodiment of the present invention.

FIG. 4 is an explanatory diagram showing examples of evaluation results of flavor of the second plant raw material liquid produced by bringing the first plant raw material liquid into contact with dried inactivated yeast, heat-treated inactivated yeast, or a yeast extract in Example 4 according to one embodiment of the present invention.

FIG. 5 is an explanatory diagram showing examples of evaluation results of relationships between amounts of the inactivated yeast with which the first plant raw material liquid is brought into contact and flavors of the second plant raw material liquids produced in Example 5 according to one embodiment of the present invention.

### DESCRIPTION OF EMBODIMENTS

Hereinafter, embodiments of the present invention are described. It should be noted that the present invention is not limited to these embodiments.

A method according to one embodiment of the present invention (hereinafter referred to as “method of the present invention”) is, for example, a method including bringing a first plant raw material liquid into contact with inactivated yeast to produce a second plant raw material liquid to be used for production of a beverage.

That is, in this case, the method of the present invention is, for example, a method including bringing a first plant raw material liquid into contact with inactivated yeast to produce a second plant raw material liquid having improved flavor compared to that of the first plant raw material liquid that has not been brought into contact with the inactivated yeast.

The first plant raw material liquid is not particularly limited as long as the liquid contains a component derived from a plant. That is, the first plant raw material liquid is prepared using a plant raw material. Specifically, the first plant raw material liquid is prepared by, for example, mixing a plant raw material and water (preferably warm water) to extract a component contained in the plant raw material.

The plant raw material is not particularly limited as long as the material can be used for production of a beverage, and may be, for example, one or more kinds selected from the group consisting of grain (for example, one or more kinds selected from the group consisting of barley, wheat, rice, and corn), beans, and potatoes and/or products obtained by allowing one or more kinds selected from the group to germinate.

Specifically, the first plant raw material liquid is, for example, a malt liquid. The malt liquid is a liquid containing a component derived from malt. The malt used preferably includes barley malt and/or wheat malt. The barley malt and the wheat malt are obtained by allowing barley and wheat to germinate, respectively. The malt liquid is prepared using malt and/or a malt extract, for example.

In a case of using the malt, the malt liquid is prepared by mixing at least malt and water (preferably warm water) to extract a component contained in the malt. The malt liquid may be prepared by saccharification. In this case, the malt liquid is prepared by mixing malt and water (preferably warm water) and subjecting the resultant mixture to saccharification. The saccharification is carried out by, for example, maintaining the mixture containing the malt and water at a temperature at which a digestive enzyme (such as an amylase or a protease) contained in the malt can act (for example, from 30 to 80° C.)

The malt extract is a composition containing a component derived from malt. That is, the malt extract is a malt extract obtained by extracting extract components containing sugar components and nitrogen components. In this case, the malt extract is prepared by, for example, extracting an extract component from the malt with water (cold water or warm water).

In a case of using the malt extract, the malt liquid is prepared by mixing at least the malt extract and water (preferably warm water). The malt extract may be prepared by extracting an extract component from the malt and subsequently performing saccharification. The malt extract may be prepared by concentration after extraction or saccharification of the malt. As the malt extract, a commercially available malt extract may be used.

The first plant raw material liquid may be prepared further using hops. In this case, the first plant raw material liquid is prepared using, for example, hops and one or more kinds selected from the group consisting of grain, beans, and potatoes and/or products obtained by allowing one or more kinds selected from the group to germinate.

Specifically, in a case where the first plant raw material liquid is a malt liquid, the malt liquid is prepared by mixing at least malt and/or a malt extract and water (preferably warm water), adding hops to the resultant mixture, and boiling the mixture. In this case, saccharification may be carried out before addition of the hops.

In addition, the first plant raw material liquid may be prepared without using the malt and the malt extract. Also in this case, the first plant raw material liquid may be prepared further using the hops.

The first plant raw material liquid is produced without alcoholic fermentation. Therefore, the first plant raw material liquid is substantially free of ethanol. That is, a content of ethanol in the first plant raw material liquid is, for example, less than 1 vol %, preferably less than 0.05 vol %, more preferably less than 0.005 vol %.

The method of the present invention may include the step of preparing the first plant raw material liquid, or may not include the step of preparing the first plant raw material liquid. In a case where the method of the present invention does not include the step of preparing the first plant raw material liquid, a first plant raw material liquid prepared in advance is used in the method of the present invention.

In the method of the present invention, such first plant raw material liquid is brought into contact with inactivated yeast. Herein, the inactivated yeast is not particularly limited as long as the yeast has been inactivated so as to substantially not perform proliferation and/or metabolism.

As the inactivated yeast, there may be used inactivated alcohol-producing yeast and/or inactivated non-alcohol-producing g yeast. The inactivated alcohol-producing yeast is, for example, alcohol-producing yeast that has been inactivated so as to substantially not produce an alcohol.

The alcohol-producing yeast is not particularly limited as long as the yeast performs alcoholic fermentation. Specifically, as the alcohol-producing yeast, there may be used, for example, one or more kinds selected from the group consisting of beer yeasts (for example, bottom fermentation beer yeast and top fermentation beer yeast), wine yeasts, shochu yeasts, sake yeasts, yeasts to be used for production of bioethanol, and bread yeasts. The non-alcohol-producing yeast is not particularly limited as long as the yeast does not perform alcoholic fermentation.

The method and conditions for the contact of the first plant raw material liquid with the inactivated yeast are not particularly limited as long as the effect provided by the contact is obtained. That is, for example, yeast inactivated in advance may be added to the first plant raw material liquid to bring the first plant raw material liquid into contact with the inactivated yeast.

In this case, the inactivated yeast to be added to the first plant raw material liquid is not particularly limited as long as the yeast has been inactivated before addition to the first plant raw material liquid, and may be, for example, dead yeast (hereinafter referred to as “dead yeast”). The dead yeast is yeast that has stopped its life activity. The dead yeast is obtained by, for example, subjecting living yeast (hereinafter referred to as “living yeast”) to one or more treatments selected from the group consisting of heat treatment, acid treatment, freezing treatment, and drying treatment.

In addition, the yeast inactivated in advance may be, for example, yeast inactivated by artificial treatment (for example, one or more treatments selected from the group consisting of genetic engineering, chemical treatment, and light (for example, UV) treatment).

In a case where the yeast inactivated in advance is added to the first plant raw material liquid, the temperature at which the first plant raw material liquid is brought into contact with the inactivated yeast is not particularly limited as long as the effect provided by the contact is obtained. That is, in this case, the method of the present invention may include, for example, bringing the first plant raw material liquid into contact with the inactivated yeast at a temperature of 0° C. or more.

In addition, for example, the living yeast may be added to the first plant raw material liquid at a temperature for inactivation of the living yeast to inactivate the living yeast and to bring the first plant raw material liquid into contact with the inactivated yeast obtained by the inactivation of the living yeast. That is, in this case, the living yeast is inactivated by heat treatment performed by adding the living yeast to the first plant raw material liquid.

The temperature for inactivation of the living yeast is appropriately determined depending on the kind of the living yeast, and in general, the living yeast is inactivated at a temperature of 40° C. or more, for example. Therefore, the temperature for inactivation of the living yeast may be, for example, 40° C. or more, 50° C. or more, or 60° C. or more. As the temperature increases, the living yeast is inactivated more reliably. It should be noted that the temperature of the first plant raw material liquid after the inactivation of the living yeast is not particularly limited, and the first plant raw material liquid may be brought into contact with the inactivated yeast obtained by the inactivation of the living yeast at 0° C. or more, for example.

In addition, the inventors of the present invention have made intensive studies, and as a result, have uniquely found that when the temperature at which the first plant raw material liquid is brought into contact with the inactivated yeast is raised, the effect provided by the contact to improve flavor is enhanced.

In view of foregoing, in the method of the present invention, the first plant raw material liquid may be brought into contact with the inactivated yeast under heating. That is, in this case, for example, the first plant raw material liquid containing the inactivated yeast is heated during the contact of the first plant raw material liquid with the inactivated yeast.

In a case where the yeast inactivated in advance is added to the first plant raw material liquid, the temperature of the heated first plant raw material liquid is not particularly limited. The temperature may be, for example, 20° C. or more, 30° C. or more, or 40° C. or more.

On the other hand, in a case where the living yeast is added to the first plant raw material liquid, the temperature of the heated first plant raw material liquid is set to a temperature at which the living yeast is inactivated at least at the time of addition of the living yeast. However, after the inactivation of the living yeast, the temperature of the heated first plant raw material liquid is not particularly limited. The temperature may be, for example, 20° C. or more, 30° C. or more, or 40° C. or more.

In addition, in the method of the present invention, the first plant raw material liquid may be brought into contact with the inactivated yeast at a temperature of 20° C. or more, 30° C. or more, or 40° C. or more regardless of heating. In this case, the first plant raw material liquid may be heated, or may not be heated. That is, for example, in a case where the temperature of the first plant raw material liquid is maintained at 20° C. or more, 30° C. or more, or 40° C. or more depending on conditions of an environment in which the method of the present invention is carried out (for example, region, season, and temperature), it is not necessary to heat the first plant raw material liquid.

In a case where the yeast inactivated in advance is added to the first plant raw material liquid, the temperature of the first plant raw material liquid is not particularly limited as long as the temperature is 0° C. or more. The temperature may be, for example, 20° C. or more, 30° C. or more, or 40° C. or more.

On the other hand, in a case where the living yeast is added to the first plant raw material liquid, the temperature of the first plant raw material liquid is set to a temperature at which the living yeast is inactivated at least at the time of addition of the living yeast. However, after the inactivation of the living yeast, the temperature of the first plant raw material liquid is not particularly limited as long as the temperature is 0° C. or more. The temperature may be, for example, 20° C. or more, 30° C. or more, or 40° C. or more.

In the method of the present invention, in a case where the first plant raw material liquid is brought into contact with the inactivated yeast as mentioned above at relatively high temperature, for example, the first plant raw material liquid may be subjected to enzymatic treatment (for example, saccharification) and/or sterilization treatment prior to the contact with the inactivated yeast, and subsequently the living yeast and/or the inactivated yeast may be added to the first plant raw material liquid that has been subjected to the enzymatic treatment and/or the sterilization treatment.

The upper limit of the temperature at which the first plant raw material liquid is brought into contact with the inactivated yeast is not particularly limited, and the temperature may be, for example, 100° C. or less, or less than 100° C.

The time for contact of the first plant raw material liquid with the inactivated yeast is not particularly limited as long as the effect provided by the contact is obtained. The time is, for example, 0.25 hour or more, or 1.00 hour or more. It should be noted that the upper limit of the time for contact of the first plant raw material liquid with the inactivated yeast is not particularly limited.

The amount of the inactivated yeast with which the first plant raw material liquid is brought into contact is not particularly limited as long as the effect provided by the contact is obtained. For example, the amount may fall within a range of from 0.01 to 3.0 wt % with respect to the first plant raw material liquid (from 0.01 to 3.0 parts by weight with respect to 100 parts by weight of the first plant raw material liquid), or a range of from 0.025 to 1.5 wt %, preferably a range of from 0.05 to 1.5 wt %, more preferably a range of from 0.1 to 1.5 wt %.

It should be noted that a method of bringing the first plant raw material liquid into contact with the inactivated yeast is not limited to a method involving adding the living yeast and/or the inactivated yeast to the first plant raw material liquid in a container and dispersing the yeast. For example, a method may be used that involves allowing the first plant raw material liquid to flow through a container immobilized in advance with the living yeast and/or the inactivated yeast (for example, a container including a carrier immobilized with the living yeast and/or the inactivated yeast).

In the method of the present invention, the first plant raw material liquid is brought into contact with the inactivated yeast as mentioned above to produce a second plant raw material liquid. The second plant raw material liquid is obtained by bringing the first plant raw material liquid into contact with the inactivated yeast and removing the inactivated yeast. It should be noted that a method of removing the inactivated yeast is not particularly limited, and for example, centrifugation and/or filtration may be employed.

In the method of the present invention, the second plant raw material liquid is also produced without alcoholic fermentation. Therefore, the second plant raw material liquid is substantially free of an ethanol. That is, the content of ethanol in the second plant raw material liquid is, for example, less than 1 vol %, preferably less than 0.05 vol %, more preferably less than 0.005 vol %.

The second plant raw material liquid produced as above has improved flavor compared to that of the first plant raw material liquid that has not been brought into contact with the inactivated yeast. That is, in the method of the present invention, the first plant raw material liquid is brought into contact with the inactivated yeast to produce the second plant raw material liquid having improved flavor compared to that of the first plant raw material liquid that has not been brought into contact with the inactivated yeast.

Specifically, for example, discordant taste of the second plant raw material liquid is effectively reduced compared to that of the first plant raw material liquid that has not been brought into contact with the inactivated yeast. In addition, for example, the flavor of the second plant raw material liquid is milder than that of the first plant raw material liquid that has not been brought into contact with the inactivated yeast.

In addition, the method of the present invention may further include producing a beverage using the second plant raw material liquid produced as above. That is, in this case, the method of the present invention is, for example, a method of producing a beverage using the second plant raw material liquid obtained by bringing the first plant raw material liquid into contact with the inactivated yeast without alcoholic fermentation.

In this case, in the method of the present invention, for example, a beverage is produced by mixing the second plant raw material liquid with any other raw material. That is, in a case of producing a non-alcoholic beverage, as the other raw material, there may be used one or more kinds selected from the group consisting of a sugar, a dietary fiber, an acidulant, a pigment, a flavoring agent, a sweetening agent, and a bittering agent.

The non-alcoholic beverage is a beverage having an ethanol content of less than 1 vol %. The ethanol content of the non-alcoholic beverage may be, for example, 0.05 vol % or less, or less than 0.005 vol %.

In addition, in the method of the present invention, the second plant raw material liquid may be mixed with an ethanol-containing liquid to produce an alcoholic beverage. In this case, any other raw material may further be mixed. As the other raw material, there may be used one or more kinds selected from the group consisting of a sugar, a dietary fiber, an acidulant, a pigment, a flavoring agent, a sweetening agent, and a bittering agent.

The alcoholic beverage is a beverage having an ethanol content of 1 vol % or more (alcohol content: 1% or more). In this case, the ethanol content of the alcoholic beverage is not particularly limited as long as the content is 1 vol % or more. The ethanol content may be, for example, from 1 to 20 vol %.

Thus, in the method of the present invention, a beverage that is reliably prevented from containing an alcohol and has excellent flavor is produced. That is, production of an alcohol in the first plant raw material liquid is reliably prevented because the first plant raw material liquid is brought into contact with the inactivated yeast. Further, the flavor of the beverage is effectively improved compared to a case of using the first plant raw material liquid that has not been brought into contact with the inactivated yeast because of the use of the second plant raw material liquid having flavor improved by contact of the first plant raw material liquid with the inactivated yeast.

Specifically, for example, discordant taste of the beverage produced using the second plant raw material liquid by the method of the present invention is effectively reduced compared to that of the beverage produced using the first plant raw material liquid that has not been brought into contact with the inactivated yeast. In addition, for example, the flavor of the beverage produced by the method of the present invention is milder than that of the beverage produced using the first plant raw material liquid that has not been brought into contact with the inactivated yeast.

In addition, the method of the present invention may be, for example, a method including bringing the plant raw material liquid into contact with the inactivated yeast to improve the flavor of the plant raw material liquid compared to that before the contact with the inactivated yeast.

That is, in this case, the method of the present invention employs bringing the plant raw material liquid into contact with the inactivated yeast as technical means for improving the flavor of the plant raw material liquid. It should be noted that the improvement in flavor of the plant raw material liquid may be confirmed by, for example, a sensory test, and specifically, is evaluated as a reduction in discordant taste and/or an increase in mildness, for example.

In addition, the method of the present invention may be, for example, a method of improving the flavor of a beverage, including using the second plant raw material liquid obtained by bringing the first plant raw material liquid into contact with the inactivated yeast to improve the flavor of the beverage compared to the case of using the first plant raw material liquid that has not been brought into contact with the inactivated yeast.

That is, in this case, the method of the present invention employs using the second plant raw material liquid obtained by bringing the first plant raw material liquid into contact with the inactivated yeast as technical means for improving the flavor of the beverage produced using the plant raw material liquid. It should be noted that the improvement in flavor of the beverage may be confirmed by, for example, a sensory test, and specifically, is evaluated as a reduction in discordant taste and/or an increase in mildness, for example.

A plant raw material liquid according to one embodiment of the present invention (hereinafter referred to as “raw material liquid of the present invention”) is a plant raw material liquid that is preferably produced by the method of the present invention as mentioned above. That is, the raw material liquid of the present invention is, for example, the second plant raw material liquid obtained by bringing the first plant raw material liquid into contact with the inactivated yeast as mentioned above. The raw material liquid of the present invention is used for production of a beverage. It should be noted that the ethanol content of the raw material liquid of the present invention may be, for example, less than 1 vol %, 0.05 vol % or less, or less than 0.005 vol %.

A beverage according to one embodiment of the present invention (hereinafter referred to as “beverage of the present invention”) is preferably produced by the method of the present invention mentioned above. The beverage of the present invention may be a sparkling beverage. The sparkling beverage has foam properties including foam-forming property and foam-stability. That is, the sparkling beverage is, for example, a beverage containing carbon dioxide gas, which has foam-forming property for forming a foam layer on the top of a liquid surface when poured in a container such as a glass and foam-stability for holding the foam for at least a certain period of time. It should be noted that a method of imparting the foam properties to a beverage is not particularly limited, and for example, use of carbonated water and/or blowing of carbon dioxide gas may be employed. The sparkling beverage may be a sparkling non-alcoholic beverage or a sparkling alcoholic beverage.

In addition, the beverage of the present invention may be a non-sparkling beverage. The non-sparkling beverage is a beverage having no foam properties mentioned above. The non-sparkling beverage may be a non-sparkling non-alcoholic beverage or a non-sparkling alcoholic beverage.

Hereinafter, specific examples according to those embodiments are described.

### Example 1

### Preparation of First Plant Raw Material Liquid

A malt liquid (wort) was prepared as the first plant raw material liquid. That is, warm water at 50° C. was added to pulverized barley malt, and the resultant mixture was maintained at 65° C. to perform saccharification. Further, husk of the barley malt was removed from the mixture after the saccharification, and then hops were added thereto, following by boiling. After the boiling, the resultant mixture was obtained as a malt liquid.

[Contact of First Plant Raw Material Liquid with Inactivated Yeast]

Dried yeast was used as the inactivated yeast. The dried yeast was inactivated yeast prepared by subjecting living bottom fermentation beer yeast to heat treatment to kill the yeast and drying the yeast. Then, 0.1 wt % of the inactivated yeast was added to the malt liquid prepared as above, and the mixture was maintained for 15 minutes at six different temperatures (0° C., 20° C., 40° C., 60° C., 80° C., or 100° C.) to bring the malt liquid into contact with the inactivated yeast.

Subsequently, the mixture was centrifuged to remove the inactivated yeast from the malt liquid to prepare, as the second plant raw material liquids, six kinds of malt liquids different in temperature for the contact with the inactivated yeast. In addition, a malt liquid that had not been brought into contact with the inactivated yeast was provided as a comparative control.

[Sensory Test]

Eight skilled panelists evaluated the seven kinds of malt liquids prepared as above by a sensory test. In the sensory test, the panelists evaluated discordant taste, mildness, and overall flavor.

[Results]

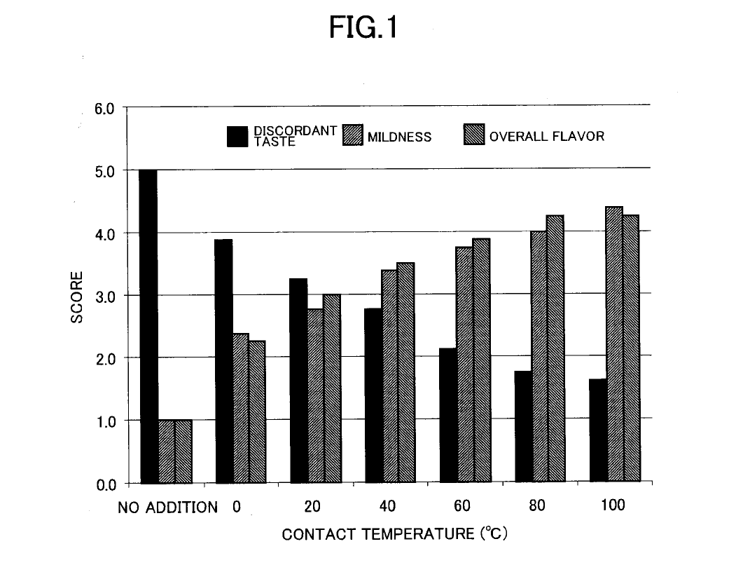

FIG. 1 shows the results of the sensory test. In FIG. 1, the horizontal axis represents a temperature (° C.) at which the malt liquid was brought into contact with the inactivated yeast, and the vertical axis represents a score of the sensory test. It should be noted that on the horizontal axis, the term “NO ADDITION” refers to a comparative example in which the malt liquid has not been brought into contact with the inactivated yeast.

FIG. 1 shows that: when the score of “DISCORDANT TASTE” was larger, the malt liquid had stronger discordant taste and was evaluated to be not preferred; when the score of “MILDNESS” was larger, the malt liquid had mild flavor and was evaluated to be preferred; and when the score of “OVERALL FLAVOR” was larger, the malt liquid was evaluated to have preferred overall flavor.

As shown in FIG. 1, the malt liquids that had been brought into contact with the inactivated yeast were evaluated to have improved flavor compared to the malt liquid that was not brought into contact with the inactivated yeast (“NO ADDITION”). That is, when the malt liquid was brought into contact with the inactivated yeast, the malt liquid had effectively reduced discordant taste, increased mildness, and improved overall flavor.

In addition, it was found that as the temperature at which the malt liquid was brought into contact with the inactivated yeast became higher, the flavor was more improved. In particular, when the temperature at which the malt liquid was brought into contact with the inactivated yeast was 40° C. or more, the flavor was significantly improved. When the temperature at which the malt liquid was brought into contact with the inactivated yeast was 60° C. or more, the flavor was more significantly improved.

### Example 2

In the same manner as in Example 1 above, a malt liquid was prepared as the first plant raw material liquid, and dried yeast was used as the inactivated yeast. Then, the inactivated yeast was added to the malt liquid at five different concentrations (0.1 wt %, 0.5 wt %, 1.0 wt %, 1.5 wt %, or 2.0 wt %), and the mixtures were maintained at 20° C. for 15 minutes to bring the malt liquid into contact with the inactivated yeast.

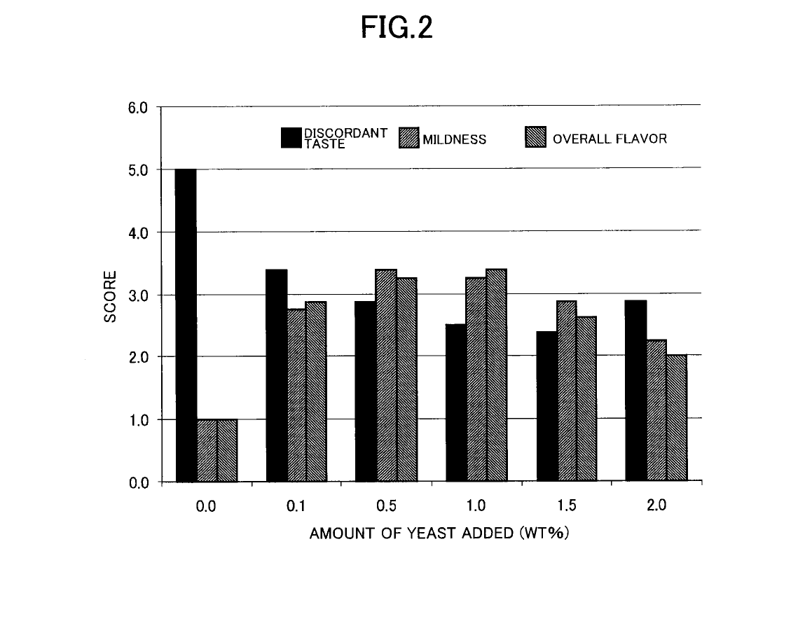

Subsequently, the mixture was centrifuged to remove the inactivated yeast from the malt liquid to prepare, as the second plant raw material liquids, five kinds of malt liquids different in amount of the contact with the inactivated yeast. In addition, a malt liquid that was not brought into contact with the inactivated yeast was provided as a comparative control. Then, a sensory test was performed in the same manner as in Example 1 above. FIG. 2 shows the results of the sensory test. In FIG. 2, the horizontal axis represents an amount (wt %) of the inactivated yeast added, and the vertical axis represents a score of the sensory test. It should be noted that the value “0.0” in the horizontal axis means a comparative example in which the inactivated yeast has not been added (the malt extract has not been brought into contact with the inactivated yeast).

As shown in FIG. 2, the malt liquids that had been brought into contact with the inactivated yeast were evaluated to have improved flavor compared to that of the malt liquid that was not brought into contact with the inactivated yeast (“0.0”). That is, when the malt liquid was brought into contact with the inactivated yeast, the malt liquid had effectively reduced discordant taste, increased mildness, and improved overall flavor. In addition, when the amount of the inactivated yeast added was from 0.1 to 1.5 wt %, the flavor was particularly significantly improved.

### Example 3

In the same manner as in Example 1 above, a malt liquid was prepared as the first plant raw material liquid, and dried yeast was used as the inactivated yeast. Then, 0.1 wt % of the inactivated yeast was added to the malt liquid, and the mixture was maintained at 20° C. for five different times (0.25 hour, 1 hour, 6 hours, 24 hours, or 48 hours) to bring the malt liquid into contact with the inactivated yeast.

Subsequently, the mixture was centrifuged to remove the inactivated yeast from the malt liquid to prepare, as the second plant raw material liquids, five kinds of malt liquids different in time for the contact with the inactivated yeast. In addition, a malt liquid that was not brought into contact with the inactivated yeast was provided as a comparative control. Then, a sensory test was performed in the same manner as in Example 1 above.

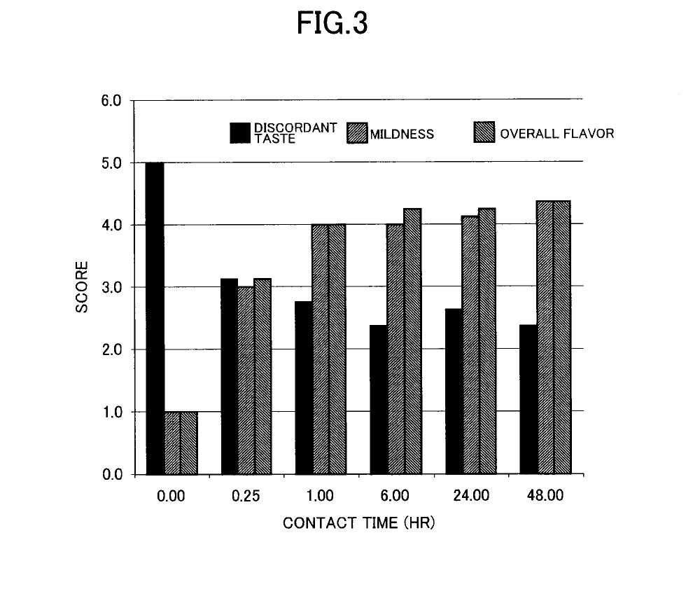

FIG. 3 shows the results of the sensory test. In FIG. 3, the horizontal axis represents a time (hours) for the contact of the malt liquid with the inactivated yeast, and the vertical axis represents a score of the sensory test. It should be noted that the value “0.0” in the horizontal axis means a comparative example in which the malt extract has not been brought into contact with the inactivated yeast.

As shown in FIG. 3, the malt liquids that had been brought into contact with the inactivated yeast were evaluated to have improved flavor compared to that of the malt liquid that was not brought into contact with the inactivated yeast (“0.0”). That is, when the malt liquid was brought into contact with the inactivated yeast, the malt liquid had effectively reduced discordant taste, increased mildness, and improved overall flavor.

In addition, it was found that, when the time for the contact of the malt liquid with the inactivated yeast was 1 hour or more, the flavor was more improved. In the case where the contact time was 1 hour or more, there was no significant change in improving effect on flavor.

### Example 4

In the same manner as in Example 1 above, a malt liquid was prepared as the first plant raw material liquid. In addition, the same dried yeast as in Example 1 above and heat-treated yeast were used as the inactivated yeasts. The heat-treated yeast was inactivated yeast prepared by subjecting living bottom fermentation beer yeast to heat treatment to kill the yeast.

Then, 0.1 wt % of the dried yeast or the heat-treated yeast was added to the malt liquid, and the mixture was maintained at 20° C. for 15 minutes to bring the malt liquid into contact with the dried yeast or the heat-treated yeast. After that, the mixture was centrifuged to remove the inactivated yeast from the malt liquid, thereby affording, as the second plant raw material liquids, two kinds of malt liquids that had been brought into contact with the dried yeast or the heat-treated yeast.

In addition, a yeast extract was used as a comparative control. The yeast extract was a composition obtained by subjecting living bottom fermentation beer yeast to enzymatic treatment to extract components such as amino acids and nucleic acids contained in the yeast and separating and removing insoluble components (for example, cell body of yeast). That is, the yeast extract was, for example, a composition containing components such as amino acids and nucleic acids derived from the yeast and not containing cell body of the yeast.

Then, 0.1 wt % of the yeast extract was added to the malt liquid, and the mixture was maintained at 20° C. for 15 minutes. After that, the mixture was centrifuged to remove the yeast extract from the malt liquid, thereby affording, as the second plant raw material liquid, a malt liquid that had been brought into contact with the yeast extract. Then, a sensory test was performed in the same manner as in Example 1 above.

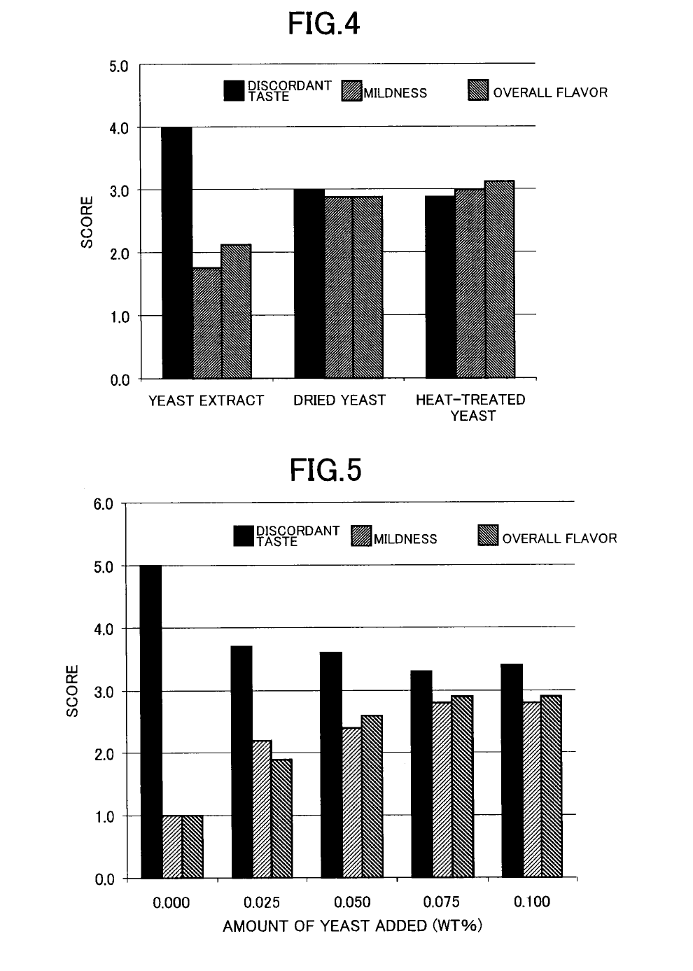

FIG. 4 shows the results of the sensory test. In FIG. 4, the horizontal axis represents the kind of the inactivated yeast that has been brought into contact with the malt liquid, or the yeast extract, and the vertical axis represents a score of the sensory test. As shown in FIG. 4, the malt liquids that had been brought into contact with the inactivated yeast were evaluated to have improved flavor compared to that of the malt liquid to which the yeast extract was added without contact with the inactivated yeast. That is, when the malt liquid was brought into contact with the inactivated yeast, the malt liquid had effectively reduced discordant taste, increased mildness, and improved overall flavor.

### Example 5

In the same manner as in Example 1 above, a malt liquid was prepared as the first plant raw material liquid, and dried yeast was used as the inactivated yeast. Then, the inactivated yeast was added to the malt liquid at four different concentrations (0.025 wt %, 0.05 wt %, 0.075 wt %, or 0.100 wt %), and the mixtures were maintained at 20° C. for 15 minutes to bring the malt liquid into contact with the inactivated yeast.

Subsequently, the mixture was centrifuged to remove the inactivated yeast from the malt liquid to prepare, as the second plant raw material liquids, four kinds of malt liquids different in amount of the contact with the inactivated yeast. In addition, a malt liquid that was not brought into contact with the inactivated yeast was provided as a control. Then, the malt liquid was subjected to the sensory test in the same manner as in Example 1 above.

FIG. 5 shows the results of the sensory test. In FIG. 5, the horizontal axis represents amounts (wt %) of the inactivated yeast added, and the vertical axis represents scores of the sensory test. It should be noted that the value “0.000” in the horizontal axis represents a comparative example where the inactivated yeast was not added (the malt liquid was not brought into contact with the inactivated yeast).

As shown in FIG. 5, the malt liquids that had been brought into contact with the inactivated yeast were evaluated to have improved flavor compared to that of the malt liquid that was not brought into contact with the inactivated yeast (“0.000”). That is, when the malt liquid was brought into contact with the inactivated yeast, the malt liquid had effectively reduced discordant taste, increased mildness, and improved overall flavor.

Specifically, for example, the malt liquid that had been brought into contact with the minimum amount, i.e., 0.025 wt % of the inactivated yeast was found to have significantly reduced discordant taste, increased mildness, and improved overall flavor compared to those of the malt liquid that was not brought into contact with the inactivated yeast. Further, when the amount of the inactivated yeast added was 0.050 wt % or more, the malt liquid had particularly significantly improved overall flavor compared to that in the case where the amount of the inactivated yeast added was 0.025 wt %.

1. A method, comprising
contacting a first plant raw material liquid with inactivated yeast thereby producing a second plant raw material liquid.

2. The method according to claim 1, wherein the first plant raw material liquid and inactivated yeast are contacted under heating.

3. The method according to claim 1, wherein contacting the first plant raw material liquid and the inactivated yeast comprises
adding a living yeast to the first plant raw material liquid at a temperature for inactivation of the living yeast thereby inactivating the living yeast, and
bringing said liquid into contact with the inactivated yeast obtained by the inactivation of the living yeast.

4. The method according to claim 3, wherein bringing of the first plant raw material liquid into contact with the inactivated yeast is at a temperature of 20° C. or more.

5. The method according to claim 1, further comprising
producing a beverage from the second plant raw material liquid.

6. The method according to claim 5, wherein the beverage is a non-alcoholic beverage.

7. A method for improving the flavor of a plant raw material liquid, comprising
contacting a plant raw material liquid with inactivated yeast thereby improving the flavor of the plant raw material liquid compared to that before the contact with the inactivated yeast.

8. A method of improving the flavor of a beverage, said method comprising
preparing the beverage from a second plant raw material liquid, wherein said second plant raw material liquid is obtained by bringing a first plant raw material liquid into contact with inactivated yeast.

9. The method according to claim 8, wherein the beverage is a non-alcoholic beverage.

10. A plant raw material liquid, which is produced by the method according to claim 1.

11. A beverage, which is produced by the method according to claim 1.

12. The beverage according to claim 11, wherein the beverage is a non-alcoholic beverage.

13. The method according to claim 2, wherein contacting the first plant raw material liquid and the inactivated yeast further comprises
removing the yeast from the raw material liquid.
